(19) United States
(12) Patent Application Publication
(10) Pub. No.: US 2010/0049564 A1
(43) Pub. Date: Feb. 25, 2010

(54) Method and Apparatus for Real-Time Automated Impact Assessment

(76) Inventors: Lundy Lewis, Mason, NH (US); Gabriel Jakobson, Brookline, MA (US); John Buford, Princeton, NJ (US)

Correspondence Address: JOHN F. BUFORD, P.O. BOX 1274, Princeton, NJ, 08542, US

(21) Appl. No.: 12/198,108

(22) Filed: Aug. 25, 2008

(51) Int. Cl. G06F 9/44

(52) U.S. Cl. 705/7

(57) ABSTRACT

A method for automated real-time impact assessment is disclosed. The method uses real-time events and alerts from monitored systems and environments such as computer networks, telecommunications networks, transportation systems, buildings, military units, emergency response teams, air traffic, medical facilities and services, chemical process plants, manufacturing assembly lines, power plants, farms, supply-chain management, businesses with workflow-based business processes, and other real-time applications which maintain situational models to depict, determine, and analyze the historical, current, and potential state of a complex set of interacting things, entities, and agents. The method shows first a means to acquire and update the relationships between entities represented in the situational view and entities such as business process, tasks, assets, and missions which are the subject of the impact assessment. The method shows second a means to automatically determine and maintain, from the situational view and other information, an evaluation of the impact on the subjects of the assessment, such entities including business processes, tasks, assets, and missions. The method shows third a means to determine impact assessment from potential and actual situations in the situational view.

This application claims priority to the U.S. provisional Patent Application Ser. No. 60/958,055 filed Aug. 25, 2007, entitled METHOD AND APPARATUS FOR CYBER SECURITY IMPACT ASSESSMENT AND SITUATION PREDICTION . . . by Lundy M. Lewis, Gabriel Jakobson, and John F. Buford.

### BACKGROUND OF THE INVENTION

This invention pertains to systems and environments in which the behavior or operation of that system is monitored in real-time, and in which an on-going assessment on the goals, missions, and processes of that system is needed. Such assessment is used by the owners, operators, commanders, or managers of the system to understand risks to the goals of that system and to prioritize responses and actions to mitigate these risks.

Conventional impact assessment methods are performed off-line. Offline impact assessments limit the ability to provide an instantaneous picture of impacts caused by one or more changes to the system. In additional, off-line mechanisms are typically qualitative and are difficult to automate because they rely on subjective findings and evaluation techniques. Further, offline impact assessment is cumbersome for dealing with changes to the goals, missions, and processes. In many applications, such changes are frequent and may not be fully known in advance. In addition, offline impact assessment techniques are difficult to apply to large-scale systems with thousands or more interrelated elements.

Offline impact assessment techniques are insufficient for systems and environments which provide real-time information about the status, state and changes to some or all of the elements of that system. Such systems include computer networks, telecommunications networks, transportation systems, buildings, military units, emergency response teams, air traffic, medical facilities and services, chemical process plants, manufacturing assembly lines, power plants, farms, supply-chain management, and businesses with workflow-based business processes.

Real-time impact assessment determines the consequences of actions and changes on the actors and entities of a system on the operational goals of that system and its components, such that the assessment is periodically updated and the assessment includes impact identification and evaluation of the degree of the impact.

Related to impact assessment is vulnerability. Vulnerability is a weakness in a system element that makes it susceptible to failure or attack. Vulnerability may be intrinsic to the element or be a result of actions affecting the state of the element. Vulnerability can change over time. The potential to exploit system vulnerability is a factor in impact assessment. An example of an element is an information technology (IT) asset, where such assets may include hardware, software, software applications, networking devices, peripherals, and the like. Other examples of an element will be forthcoming and readily understood. A safeguard is any means to reduce vulnerability.

Related to impact assessment is risk assessment. A risk is the potential for an element or component or agent of an operation to not completely achieve its objective. A risk assessment is the determination and evaluation of risks for a process, goal or mission.

Related to impact assessment are threats. Threats are incomplete and active attacks.

Related to impact assessment are attacks. An attack is a sequence of hostile actions with a goal to a) compromise the integrity, confidentiality or availability of protected resources, or b) incapacitate the system's mission-oriented operational capabilities, functions and performance. An attack may be performed by a single attacker or may be result of coordinated efforts of multiple attackers.

### SUMMARY OF THE INVENTION

The present invention is directed to various aspects of real-time impact assessment. A system or environment has a set of assets, elements, resources, and agents which may be interrelated. Some subset of the assets, elements, resources, and agents are in use at various times to perform missions, processes, and tasks for one or more goals of the owners, managers, commanders, and operators of the system or environment. In the context of this invention, a mission, process, task, or procedure is to be taken as kinds of goal-oriented activities. Other goal-oriented activities will be readily apparent depending upon the application domain. For example, in the military domain the word “mission” is often used. In the business domain, the words “process” or “business process” is often used.

There may be external agents, forces, and conditions which interfere with the function of the assets, elements, resources, and agents. The actions of such external agents, forces, and conditions may vary from time to time, and may be intentional, inadvertent, accidental, or providential.

Assets, elements, resources, and agents of the system or environment may malfunction or fail. They may interfere with the function of other assets, elements, resources, and agents due to design, infiltration, or other reasons.

The missions, processes and tasks correspond to units of an operational goal-directed view of the system or environment. The assets, resources, elements, and agents of the system or environment are organized or used to achieve, perform, or execute missions, processes and tasks. The organization or use of assets, resources, elements, and agents for missions, processes, and tasks may be called a mapping of the latter to the former. It may also be called a set of relationships or dependencies between the latter and the former.

The assets, elements, resources, and agents of the system or environment may be shared by two or more missions, process, and tasks. The use of specific assets, elements, resources and agents for a mission, process or task may vary by time.

The method for real-time automated impact assessment uses a method to obtain a real-time situational view of the assets, elements, resources, and agents of a system. Such a method is disclosed in U.S. patent application Ser. No. 10/907,483 filed Apr. 2, 2005, entitled Method and Apparatus for Situation-Based Management . . . by Lundy Lewis, Gabriel Jakobson, John Buford, which is included here in its entirety by reference.

Assets and elements and agents of a system are monitored in real-time. Such monitoring includes sensors, human intelligence, and computational agents. Monitoring elements produce notifications, events, and alerts of changes the associated assets, elements, resources, and agents of the system. These notifications, events, and alerts are processed by a real-time situation-based management system to create and maintain a situational view of the individual and collective elements of the system. In the context of this invention, the terms notifications, event, and alerts are to be taken as synonymous. Other synonyms will be readily available depending upon the application domain. For example, in some domains the term “message” is used.

In addition, the situational view includes predicted situations about potential future situations of the individual and collective elements. A method for real-time determination of predicted and potential situations is disclosed in U.S. patent application Ser. No. 10/907,487 filed Apr. 2, 2005, entitled Method and Apparatus for Creating and Using Situation Transition Graphs in Situation-Based Management . . . by Gabriel Jakobson, Lundy Lewis, John Buford, which is included here in its entirety by reference. Predicted situations are also called projected situations. A situational view is synonymous with a collection of situations. Situation manager is synonymous with situation-based manager, and situation management is synonymous with situation-based management.

The method for real-time impact assessment determines the relationships between the situational view of the elements and the missions, processes, and tasks of the system. This determination may be pre-defined, discovered, learned, or otherwise acquired. Techniques for discovering, learning or acquiring these relationships include pattern recognition, compilation, machine learning, inference, statistical correlation, data mining, and algorithms.

In one embodiment, these relationships are called a dependency graph.

In one embodiment, these relationships are called a constraint graph.

The method for real-time impact assessment determines the relationships between the missions, processes, and tasks of the system. This determination may be pre-defined, discovered, learned, or otherwise acquired. Techniques for discovering, learning or acquiring these relationships include pattern recognition, compilation, machine learning, inference, statistical correlation, data mining, and algorithms. The relationships may change over time as the scope of missions, processes, and tasks change or complete or as new missions, processes, and tasks are added. The relationship may be modeled as algorithmic tree structures where the root node represents final impact and the propagation of leaf node values produces the final impact value, dependency directed graphs, probabilistic frames, and expert systems. Confidence values may utilize Bayesian probability propagation, Markov models or anytime algorithms.

For one or more missions, processes, and tasks of the system, the method evaluates the related situations, missions, processes, and tasks and determines the impact of the situations on the missions, processes, and tasks. The evaluation of an impact may be presented as a numeric score, as a measure of likelihood of success, as a fuzzy evaluation, as a qualitative evaluation, or some other metric suitable for ordering different outcomes according to preference.

When a situation changes in the situational view for the assets, elements, resources and agents, the method may revise the evaluation of the impact on the related missions, process, and tasks. The revised evaluation of an impact may be presented as a numeric score, as a measure of likelihood of success, as a fuzzy evaluation, as a qualitative evaluation, or some other metric suitable for ordering different outcomes according to preference. The history of the revised evaluations may be included in the presentation.

The real-time impact assessment may be presented to the user through a computer-based user interface. The real-time impact assessment may be stored and updated in a database or other storage mechanism. The real-time impact assessment may be delivered over a network to software agents. Such agents or software processes might include the agents or software processes performing missions, processes, and tasks. The real-time impact assessment may be incorporated in to one or more situations in the situational view.

In one embodiment, the system is a computer network operated by a business with assets including computers, software applications, network equipment, wireless networks, terrestrial links, and optical fiber, and agents include business personal. The business defines business processes using workflow management software. Assets are monitored using conventional network and system management agents. A situation-based manager creates and maintains the situational view of the assets using notifications, events, alerts, and human intelligence. The method for real-time impact assessment determines the relationship between the situational view and the business processes, and evaluates the situational view to determine the impact on each business process. From time to time, assets change states; business processes execute, complete, or start; and relationships between situations and business processes change. The method re-evaluates the relationships and the impacts.

In one embodiment, the system is a computer network with assets and agents, operated for business processes or missions, in which the computer network assets, elements, and resources are subject to cyber attacks which may impact the associated processes and missions. The situation-based manager detects attacks by a multi-stage process of correlating infrastructure events into IDS/sensor alerts and then correlates them into attack detection alerts. Such attacks are usually aimed at the information technology infrastructure components (routers, hosts, servers, firewalls, communications links, etc.) and through the dependencies between the infrastructure components and the supported services, and between the services and the associated missions affect the services and missions. Attack impact may also propagate through the components on the information technology infrastructure level due to the existing inter-component configuration dependencies. Parameters for characterizing the health of information technology services are fairly well-known and include availability, response time, and quality-of-service.

In one embodiment, the system is a military unit and assets include military equipment and agents include soldiers. The goal of the system is determined by the commanders and described by one or more missions. Such missions include
1. off-line intelligence analysis and long-term planning
2. real-time intelligence gathering, including data collection using a fusion network
3. logistics, supply chain, facilities management
4. force readiness: asset maintenance, scheduling, operations
5. battle related: combat flights, air reconnaissance, air patrol, space telemetry attacks

In one embodiment the method for real-time impact assessment uses constraint satisfaction algorithm. Other algorithms that may be used for impact assessment include a neural network, a genetic algorithm, and a graph search algorithm. Other known algorithms for solving a constraint satisfaction problem are readily available. A constraint satisfaction problem is stated as follows:

Given the following three items,

A set of variables X={x₁, x₂, . . . , xₙ}

For each variable xᵢ, a set of values Vᵢ={Vᵢ₁, Vᵢ₂, . . . , Vᵢₘ}

A set of consistent constraints C restricting the values the variables can take simultaneously

Find an assignment of values that satisfies all the constraints.

In the constraint satisfaction paradigm, the set of constraints is a program. A set of constraints is exemplified in the following program steps, where the possible values for each variable are retrieved from data dictionaries via a find function:

Given missions, tasks, services, assets, logical connections, attack models, and alerts:
1. Find any missions and mission steps that are dependent upon some set of services
2. Find any assets upon which said services depend
3. Find any known vulnerabilities of said assets
4. Find any attack models that involve said vulnerabilities
5. Find any alerts that indicate exploitations of said assets and vulnerabilities
6. Report current mission impact based on said exploitations and a proof thereof
7. Find any second assets and known vulnerabilities reachable from first assets in #5
8. Find any services, missions, and mission steps that would be affected if second assets were compromised
9. Report possible mission impact if a second asset were compromised and a proof thereof

### BRIEF DESCRIPTION OF THE FIGURES

FIG. 1 shows an ontology of real-time impact assessment

FIG. 2 shows real-time impact assessment in which impact is assessed or projected based on detected or projected situations

FIG. 3 shows dataflow of real-time impact assessment

FIG. 4 shows an attack, fault or state change graph in which detected or projected situations are described by probability measurements

FIG. 5 shows a sample mission

FIG. 6 shows a constraint model of real-time impact assessment

FIG. 7 shows the elements of real-time impact assessment.

### DETAILED DESCRIPTION

As will be apparent to those familiar with the art, the invention may be embodied in other specific forms without departing from the spirit or essential characteristics thereof.

The method for real-time impact assessment first determines the relationships between the situational view of the elements and the missions, processes, and tasks of the system.

The method for real-time impact assessment second determines the relationships between the missions, processes, and tasks of the system.

The method third evaluates the related situations, missions, processes, and tasks and determines the impact of the situations on the missions, processes, and tasks.

The evaluation of an impact may be presented as a numeric score, as a measure of likelihood of success, as a fuzzy evaluation, as a qualitative evaluation, or some other metric suitable for ordering different outcomes according to preference.

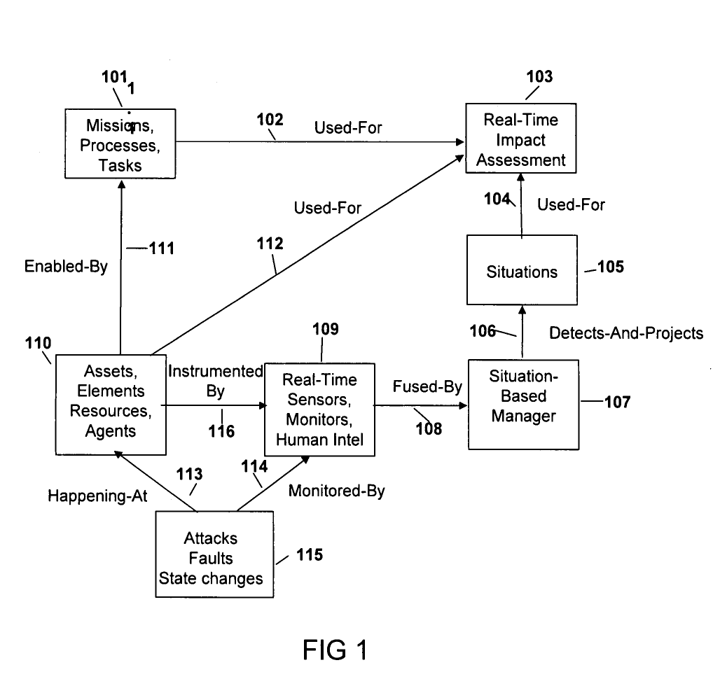

An ontological view shown on FIG. 1. is one way to describe real-time impact assessment. In FIG. 1. situations 105, attacks, faults and state changes 115, sensors, monitors and human intelligence 109, assets, elements, resources and agents 110, missions, processes and tasks 101, impact assessment 103, and situation-based manager 107 are engaged in domain-specific relations, particular (a) missions, processes and tasks 101 are Used-For 102 real-time impact assessment; (b) situations 105 are Used-For 104 real-time impact assessment; (c) assets, elements, resources and agents 110 are Used-For 112 real-time impact assessment; (d) missions, processes and tasks 101 are Enabled-By 111 assets, elements, resources and agents 110; (e) assets, elements, resources and agents 110 are Instrumented-By 116 real-time sensors, monitors and human intelligence 109; (f) attacks, faults and state changes 115 are Happening-At 113 assets, elements, resources and agents 110; (g) attacks, faults and state changes 115 are Monitored-By 114 real-time sensors, monitors and human intelligence 109; (h) real-time sensors, monitors and human intelligence 109 are Fused-By 108 situation-based manager 107; and (i) situation-based manager 107 Detects-And-Projects 106 situations 105

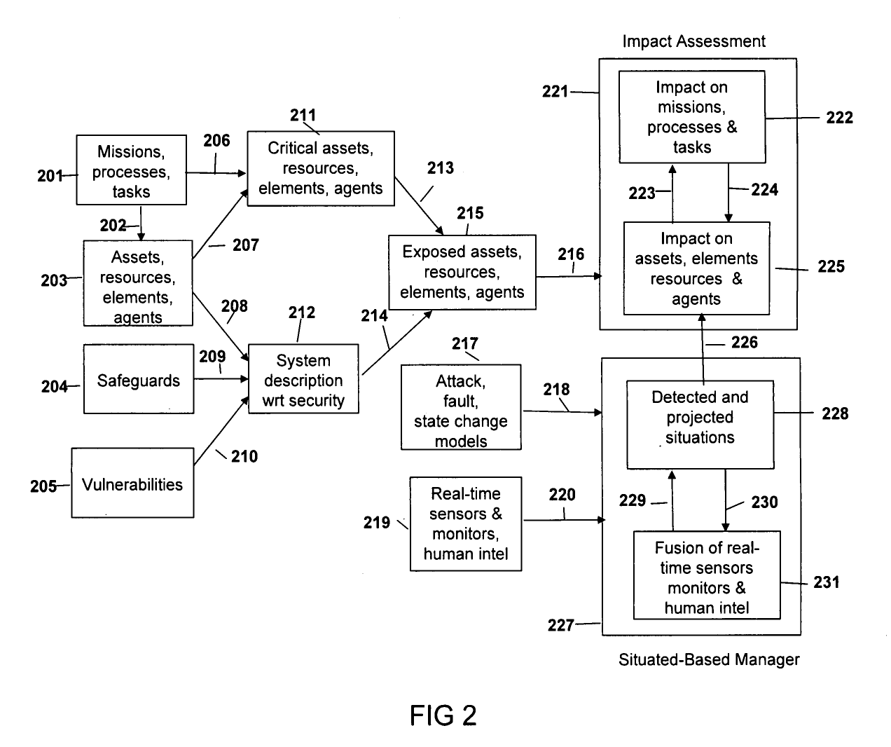

FIG. 2 shows the dataflow of real-time impact assessment, where the output 220 from real-time sensors, monitors, and human intelligence 119 is fused in real-time 231 in the situation-based manager 227. The fused information 229 is passed for detecting and projection of situations 228, as well the feedback loop 230 is used for tuning and focusing the fusion of real-time sensors, monitors and human intelligence 231. The detection and projection of situations 228 is based the models of attacks, faults and state change models 217 passed 218 to the situation-based manager 227. The detected and projected situations 228 are used 226 assessment of impact on assets, elements, resources and agents 225 within the impact assessment component 221. The impact on assets, elements, resources and agents 225 is determined on the basis of determined exposed assets, resources, elements and agents 215 that are passed 216 to the impact assessment component. Impact on assets, elements, resources and agents 225 is used 223 for determining the impact on missions, processes and tasks 225. The feedback 224 from impact on missions, processes and tasks for tuning and focusing impact on assets, elements, resources and agents 225. The exposed assets, resources, elements and agents are determined based on critical assets, resources, elements and agents 211 and the system description with regard the security 212. The corresponding data flows 213 and 214 are passed to the exposed assets, resources, elements and agents 215. The known missions, processes and tasks 201 determine 202 the scope of assets, resources, elements and agents 203 and the critical subset 211 of them. The assets, resources, elements and agents 203, safeguards 204, vulnerabilities 205 are used determine the system description with regard the security 212.

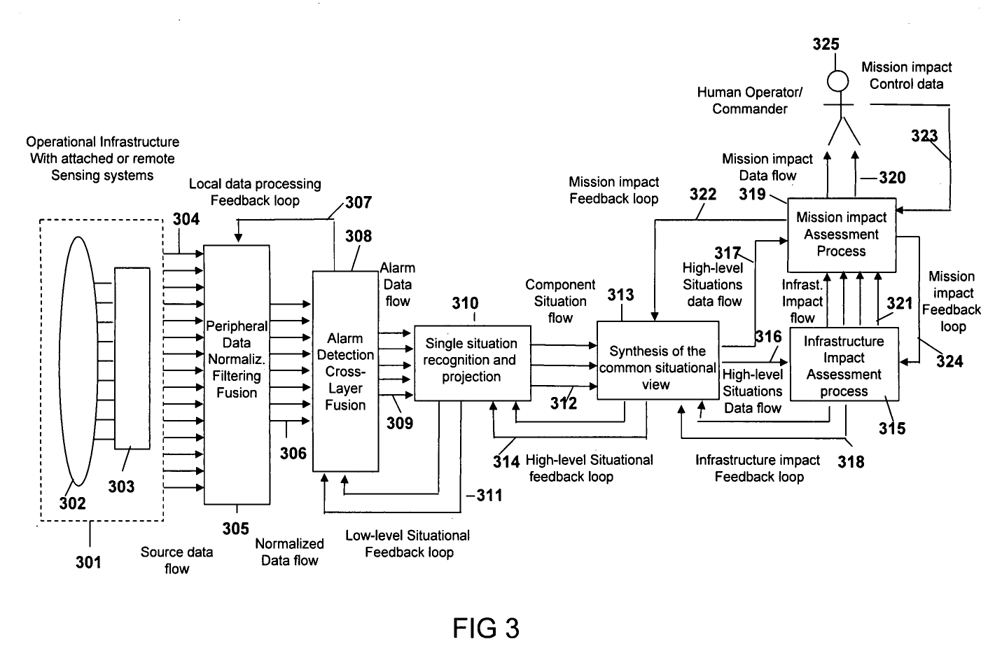

In FIG. 3 depicts a dataflow of real-time impact assessment from initial operational infrastructure with attached or remote sensing systems 301 through intermediate processes 305, 308, 310, 313, 315 and 316 and ending with providing mission impact information to the human operator or commander 325. As it is shown in FIG. 1 this is not a linear dataflow, but contains several feedback data flows 307, 311, 314, 318, 322, 323 and 324, which are used for control and system tuning purposes. The primary source data flow 304 is generated by attached or remote sensing and monitoring devices 303 or is obtained from human intelligence. The primary source data flow 303 describes the parameters, state and behavior of operational infrastructure 302 elements, assets, resources and agents. The peripheral data normalization, filtering and fusion process 305 performs the initial tasks of normalization of dissimilar, heterogeneous, multi-format source data; filtering redundant, duplicate, irrelevant or otherwise low priority; and local data fusion depending on restricted local operational context. Tuning of the processes of peripheral data normalization, filtering and fusion is automatically performed using the local data processing feedback loop 307 from the alarm detection and cross-layer fusion process 308. The alarm detection and cross-layer fusion process 308 using the algorithms of real-time pattern-matching and real-time event correlation detects the attacks, faults or system changes and generates automatically corresponding alarm data flow 309, which is passed to the single situation recognition and projection process 310. The single situation recognition and projection process 310 detects automatically single attack, fault or system change component situation 312 that are passed to the process of synthesis of the common situational view 313. The single situation recognition and projection process 310 provides low-level situational feedback loop 311 to the alarm detection and cross-layer fusion process 308 that is used for tuning and optimization of algorithms of the alarm detection and cross-layer fusion process 308. By the same token the process of synthesis of the common situational view 313 automatically generates the high-level situational feedback loop 314 that is used by the single situation recognition and projection process 310. The process of synthesis of the common situational view combines single operational situations 312 into one coherent high-level situational view, aka high-level situations data flow 316, which is passed to the infrastructure impact assessment process 315. The infrastructure impact assessment process 315 calculates the impacts on infrastructure elements, assets, resources and agents and automatically generates infrastructure impact flow 321 that is forwarded to the mission impact assessment process 319. The Process of synthesis of the common situational view 313 also forwards the high-level situations data flow to the mission impact assessment process 319 enabling so the direct mission impact assessment. The infrastructure impact assessment process generates automatically infrastructure impact feedback loop 318 that is used for automatic tuning and optimization of the process of synthesis of the common situational view 313. The similar feedback loop 322 is produced by the mission impact assessment process 319 and passed to the process of synthesis of the common situational view 313. The mission impact assessment process 319 automatically calculates the impacts on the missions, processes and tasks and passes the corresponding mission impact dataflow 320 to the human operator or commander 325. In addition the mission impact assessment process 319 automatically generates mission impact feedback loop 324 that is passed to the infrastructure impact assessment process 315. Human operator or commander 315 provides mission impact control data feedback 323 to the mission impact assessment process 319.

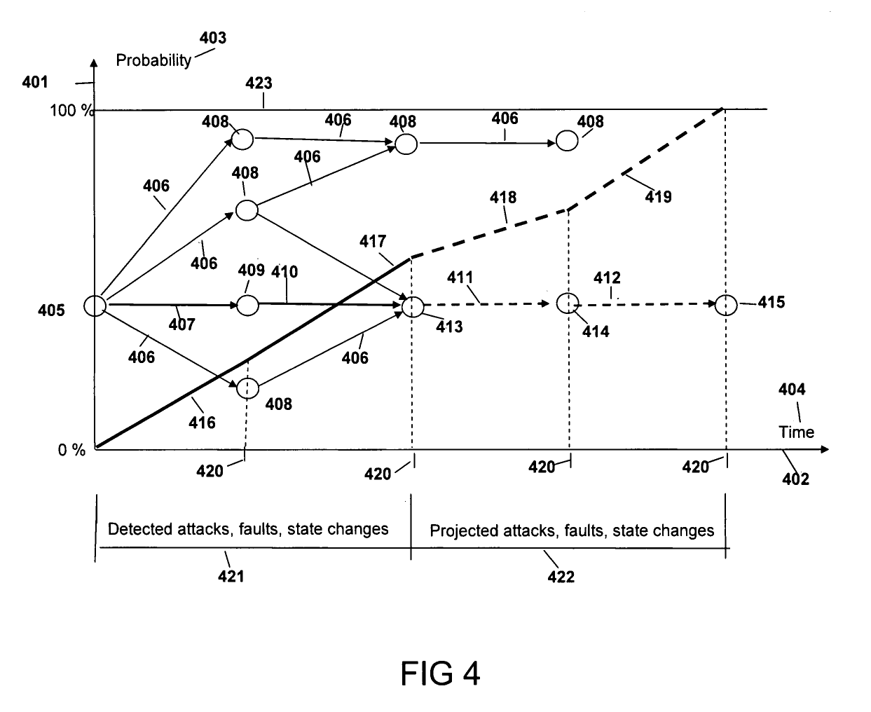

In FIG. 4 the unfolding of a multi-step attack, or fault, or a state change is illustrated in two-dimensional coordinates 401 and 402, where the dimension 401 represents probability 403 of an attack, or fault, or state change, and dimension 402 represents the time 404 of occurrence of the attack, or fault, or state change. The multiple consequent steps of an attack, fault, or state change are represented by situation transition graph (STG), which contains attack, fault, state change situations 405, 408, 409, 413, 414 and 415, and stages of an attack, fault, state change 406, 407, 410, 411 and 412. Situation 405 is the initial situation. The occurrence of attacks, faults, and state changes determine to transition of the system from one situation to another one. The situation transitions occur on time moments 420. There are detected attacks, faults and state changes 407, 410, 421 and projected attacks, faults and state changes 422. For example, attacks 407 and 410 are detected, and attacks 411 and 412 are projected attacks. In association with this, situations 409 and 413 are detected, and situations 414 and 415 are projected situations. For example, situation 415 is the terminal attack situation, which is reached due the occurrence of the last attack 412 in a sequence of a multi-stage attack 407, 410, 411 and 412. Occurrence of an attack, fault of state change is described by probability graph 416, 417, 418 and 419, which represents the intermediate probability of the final attack, fault or state change. For example probabilities 416 and 417 describe the intermediate probability of the final attack situation 415 after the attacks 407 and 410 have occurred, respectively. The probabilities 418 and 419 describe the probabilities of final attack situation 415 after the projected attacks 411 and 412, respectively.

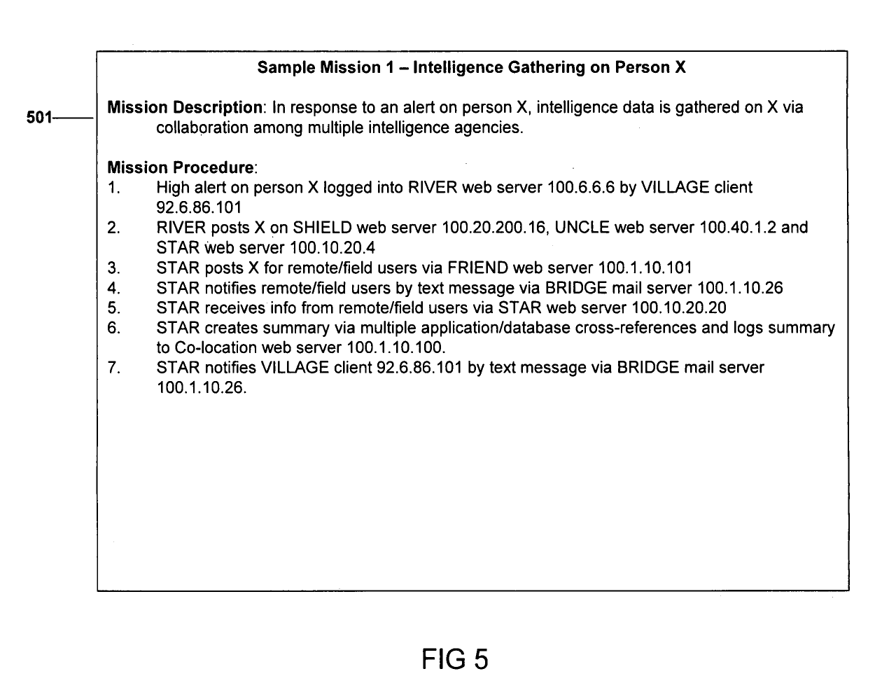

FIG. 5 illustrates a sample Mission1—Intelligence Gathering on Person X. The mission contains several consequent tasks of (1) posting a request of intelligence gathering, (2) sending the request to different information collection, storage maintenance systems, (3)-(4) further forwarding the requests to additional systems and inter-system communication, (5) receiving intelligence reports, (6) fusion of receive intelligence reports, and (7) notification of the initial client on completion of the requested intelligence gathering request. Each of the step (1)-(7) is enabled by the services and infrastructure assets, resources and elements, which are subjects of attacks, faults, and system state changes.

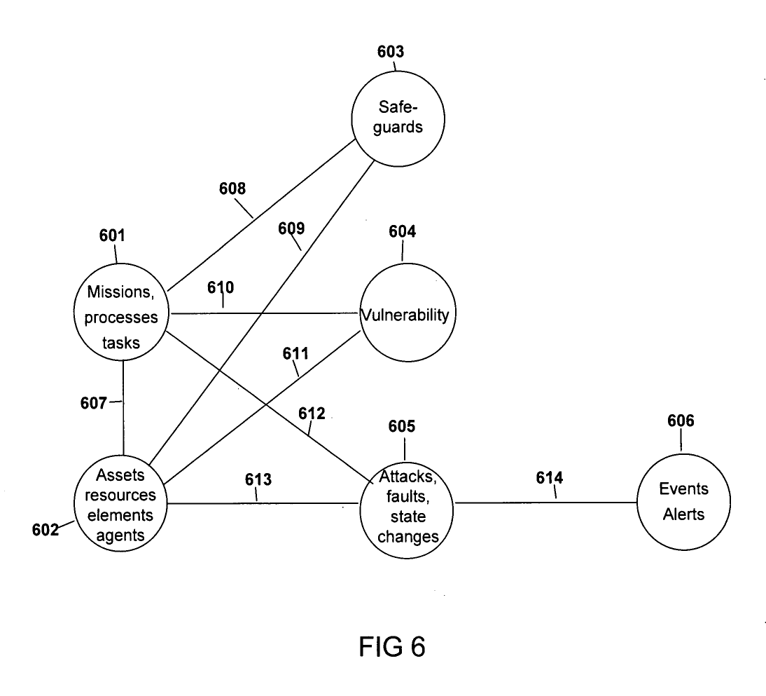

In FIG. 6 shows a constraint model of real-time impact assessment containing (a) entities of the constraint model: missions, processes and tasks 601; assets, resources, elements and agents 602; safeguards 603; vulnerabilities of assets, resources, elements and agents 604; attacks, faults, state changes 605; events and alerts 606, and (b) constraints relationships between the entities 608-614. The constraint relationships 608-614 can be undirected, unidirectional, or bi-directional. The constraint relationships 608-614 can be logical, computational, analytic, qualitative, precise, inexact, and incomplete. The constraint relationships 608-614 can be modeled by constraint logic programming, neural nets. Bayesian networks, OR methods, graph theory, first order and higher order predicate calculus. The goal of impact assessment is to find the value of entities 601-606, which satisfy the constraints 607-614 so that from instant situational picture of the entities (the instant value of the entities 601-606) the final state of the missions, processes and tasks (the impact) 601 can be effectively determined.

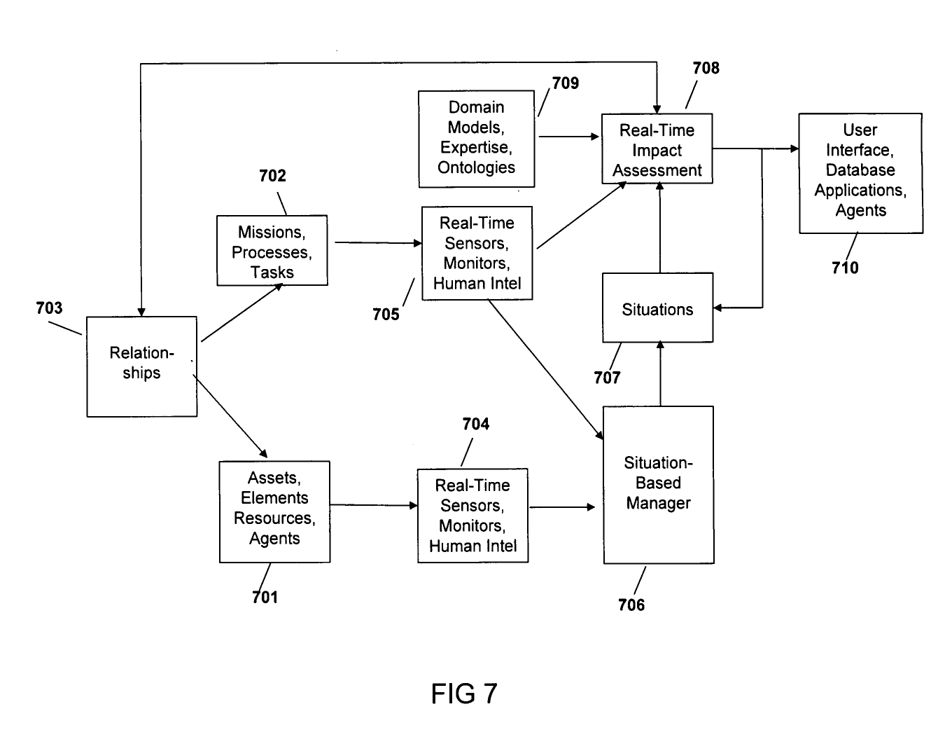

FIG. 7 shows elements of real-time impact assessment. A system or environment has a set of assets, elements, resources, and agents 701 which may be interrelated. Some subset of the assets, elements, resources, and agents are in use at various times to perform the missions, processes, and tasks 702 for one or more goals of the owners, managers, commanders, and operators of the system or environment. The missions, processes and tasks 702 correspond to units of an operational goal-directed view of the system or environment. The organization or use of assets, resources, elements, and agents 701 for missions, processes, and tasks 702 forms relationships 703 between the former and the latter. The use of specific assets, elements, resources and agents 701 for a mission, process or task may vary by time. Assets, resources, elements and agents 701 of a system are monitored in real-time. Such monitoring 704 includes sensors, human intelligence, and computational agents. Missions, processes and tasks 702 may be monitored in real-time. Such monitoring 705 includes sensors, human intelligence, and computational agents. Monitoring elements produce notifications, events, and alerts of changes the associated assets, elements, resources, and agents of the system.

In FIG. 7, these notifications, events, and alerts are processed by a real-time situation-based management system 706 to create and maintain a situational view 707 of the individual and collective elements of the system. The situational view may include predicted situations about potential future situations of the individual and collective elements. The method for real-time impact assessment determines the relationships 703 between the situational view 707 of the elements and the missions, processes, and tasks 702 of the system. This determination may be pre-defined, discovered, learned, or otherwise acquired. The method for real-time impact assessment determines the relationships 703 between the missions, processes, and tasks 702 of the system. This determination may be pre-defined, discovered, learned, or otherwise acquired. For one or more missions, processes, and tasks 702 of the system, the method evaluates the related situations 707, missions, processes, and tasks 702 and determines the impact 708 of the situations 707 on the missions, processes, and tasks 702. The determination of the impact assessment 708 may involve domain models, expertise, and ontologies 709.

In FIG. 7, when a situation changes in the situational view 707 for the assets, elements, resources and agents 701, the method may revise the evaluation of the impact assessment 708 on the related missions, process, and tasks 702. The real-time impact assessment 708 may be presented to the user through a computer-based user interface 710. The real-time impact assessment 708 may be stored and updated in a database or other storage mechanism 710. The real-time impact assessment 708 may be delivered to software agents 710 or applications 710.

Although certain preferred embodiments of the invention have been specifically illustrated and described herein, it is to be understood that variations may be made without departing from the spirit and scope of the invention as defined by the appended claims. Thus all variations are to be considered as part of the invention as defined by the following claims.

What is claimed is:

1. A method for providing impact assessment, the method comprising the acts of:
a) receiving a collection of situations;
b) receiving a collection of goal-oriented activities;
c) receiving a collection of relationships;
d) optionally acquiring a collection of relationships;
e) creating an impact assessment.

2. The method of claim 1, wherein act a) includes a situation composed of one or more of an alert, attack model, service, asset, asset configuration, asset vulnerability, asset safeguard, or asset status.

3. The method of claim 1, wherein act b) includes a goal-oriented activity composed of one or more sub-activities.

4. The method of claim 1, wherein act c) includes relationships between situations and goal-oriented activities.

5. The method of claim 1, wherein act d) includes relationships between situations and goal-oriented activities.

6. The method of claim 1, wherein act d) is performed by one or more of pattern recognition, compilation, machine learning, inference, statistical correlation, data mining, or algorithms.

7. The method of claim 1, wherein act e) includes creating an impact assessment for one or more of a goal-oriented activity, a service, or an asset.

8. The method of claim 1, wherein act e) includes creating an impact assessment accompanied by one or more of degree of likelihood, a certainty factor, a probability, or order of preference.

9. The method of claim 1, wherein act e) is performed by one or more of a constraint satisfaction algorithm, a genetic algorithm, a neural network system, or a graph search algorithm.

10. An apparatus comprising an impact assessment module, having as input a collection of situations, a collection of goal-oriented activities, and a collection of relationships; and having as output an impact assessment.

11. The apparatus of claim 10, wherein the input includes a situation composed of one or more of an alert, attack model, service, asset, asset configuration, asset vulnerability, asset safeguard, or asset status.

12. The apparatus of claim 10, wherein the input includes a goal-oriented activity composed of one or more sub-activities.

13. The apparatus of claim 10, wherein the input includes relationships between situations and goal-oriented activities.

14. The apparatus of claim 10, wherein the input includes relationships that are one or more of received or acquired.

15. The apparatus of claim 10, wherein the output includes an impact assessment for one or more of a goal-oriented activity, a service, or an asset.

16. The apparatus of claim 10, wherein the output includes an impact assessment accompanied by one or more of degree of likelihood, a certainty factor, a probability, or order of preference.

17. The apparatus of claim 10, wherein the output is determined by one or more of a constraint satisfaction algorithm, a genetic algorithm, a neural network system, or a graph search algorithm.

18. An apparatus for providing impact assessment, the apparatus comprising: means to receive a collection of situations; means to receive a collection of goal-oriented activities; means to receive a collection of relationships; optional means to acquire a collection of relationships; and means to create an impact assessment based on the collection of goal-oriented activities, the collection of situations, and the collection of relationships.
